(19) United States
(12) Patent Application Publication
(10) Pub. No.: US 2019/0300280 A1
(43) Pub. Date: Oct. 3, 2019

(54) WASTE CONTAINER WITH IMPROVED LOWER GRAB BAR

(71) Applicant: Cascade Engineering, Inc., Grand Rapids, MI (US)

(72) Inventors: Richard Thomas Peek, Caledonia, MI (US); Jeffrey Eric Totten, Stanwood, MI (US); Brian Gary Parker, Alto, MI (US)

(21) Appl. No.: 16/271,125

(22) Filed: Feb. 8, 2019

Related U.S. Application Data
(60) Provisional application No. 62/649,188, filed on Mar. 28, 2018.

(51) Int. Cl. B65F 1/12; B65F 1/14; B65F 1/02

(52) U.S. Cl. CPC B65F 1/122; B65F 1/02; B65F 1/1473

(57) ABSTRACT

The specification discloses a waste container including a lower grab bar having a self-adjusting length to accommodate flexure of the container and to ease installation of the grab bar in the container. The grab bar includes an outer tube, a plunger slidably received within the outer tube, and a spring within the tube. The spring biases the plunger outwardly with respect to the tube, so that the grab bar has a compressed position and an uncompressed/expanded position.

### BACKGROUND

The present invention relates to waste containers, and more particularly to waste containers including grab bars.

Wheeled waste carts and other waste containers are well known and commonly used in residential areas. Bags of waste (and/or recyclables) that a resident accumulates during a given week (or other pickup period) are typically stored in a waste cart. On a scheduled day, the resident wheels the cart to the curb for pickup by a waste truck, with the contents of the cart then can be dumped into the truck.

The dumping may occur manually or using machinery on the truck that is adapted to automatically lift the waste cart, turn the cart over and dump its contents into the truck. On some trucks, the machinery includes arms that grasp the sides of the cart. On other trucks, the machinery includes a lifting plate with a catch mechanism on the front face of the plate that interfaces with a lift pocket, bar, and/or other lifting structure on the cart. Typically, below the lift pocket is a bar, generally called the lower grab bar—or just the grab bar. The grab bar is latched on to by hooks extending out of the face of the lifting plate. The hooks latch onto the grab bar to keep the waste cart from following the waste into the truck when tipped into the truck.

The grab bar is typically made of metal, fiberglass, or plastic. The bar extends through openings into wall portions of the cart area to prevent the ends of the bar from sliding back through either of the openings, the bar is typically long enough so that the ends of the bar reach or nearly reach the inner surfaces of the sides of the cart. As the cart is grasped, lifted and dumped, the lifting machinery flexes the cart. Such flexure changes the width and the shape of the lift pocket, and consequently the fixed-length bar can become dislodged from the cart.

In efforts to more securely retain the bars within the carts, and especially with shorter bars, retainer pins and/or clips can be included to further secure the grab bars within the cart. The pins and clips can be part of and/or secured to the bar.

However, the ever-faster mechanisms for lifting and tipping the carts put ever-increasing forces on the grab bars and the carts. The additional forces cause the cart to flex. If the cart flexes “too much,” the grab bar can come out of the cart, thereby allowing the cart to accidentally go into the truck.

### SUMMARY

The noted problems are addressed by the present invention in which a lower grab bar has a self-adjusting length to accommodate flexing of the cart in which the bar is installed.

In the disclosed embodiment, the grab bar includes an outer tube, a plunger slidably received within the outer tube, and a spring within the tube and biasing the tube to an expanded position. The compressible and expandable grab bar “self-adjusts” to flexure of the container.

These and other features and advantages of the invention will be more fully understood and appreciated by reference to the entire application including the specification, the claims, and the drawings.

### BRIEF DESCRIPTION OF THE DRAWINGS

FIG. 1 is a perspective view of a waste cart in accordance with the present invention.

FIG. 2 is a sectional view taken along line 2-2 in FIG. 1 showing the grab bar partially installed in the cart in a first installation method.

FIG. 2A is a fragmentary sectional view similar to FIG. 2 showing the grab bar partially installed in the cart in a second installation.

FIG. 3 is a sectional view similar to FIG. 2 showing the grab bar fully installed in the cart.

FIG. 4 is a perspective exploded view of the grab bar.

FIG. 5 is a sectional view of the grab bar in its expanded or uncompressed configuration.

FIG. 6 is a sectional view of the grab bar in its compressed configuration.

### DESCRIPTION OF THE CURRENT EMBODIMENTS

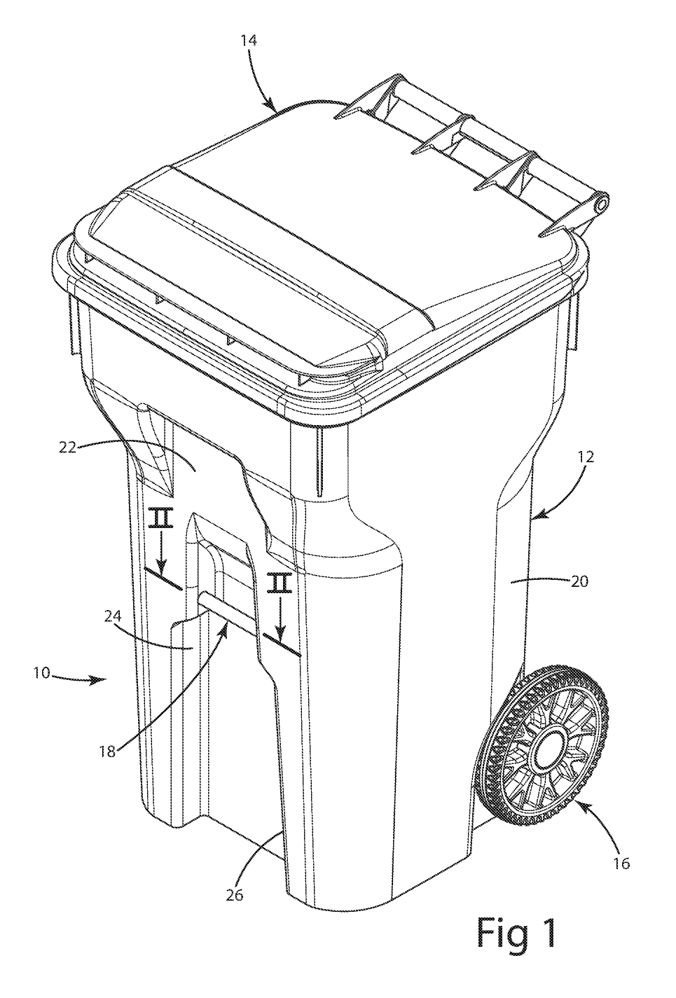

A wheeled waste container or cart is shown in FIG. 1 and is generally designated 10. The cart 10 includes a container 12, a lid 14, wheels 16, and a grab bar 18.

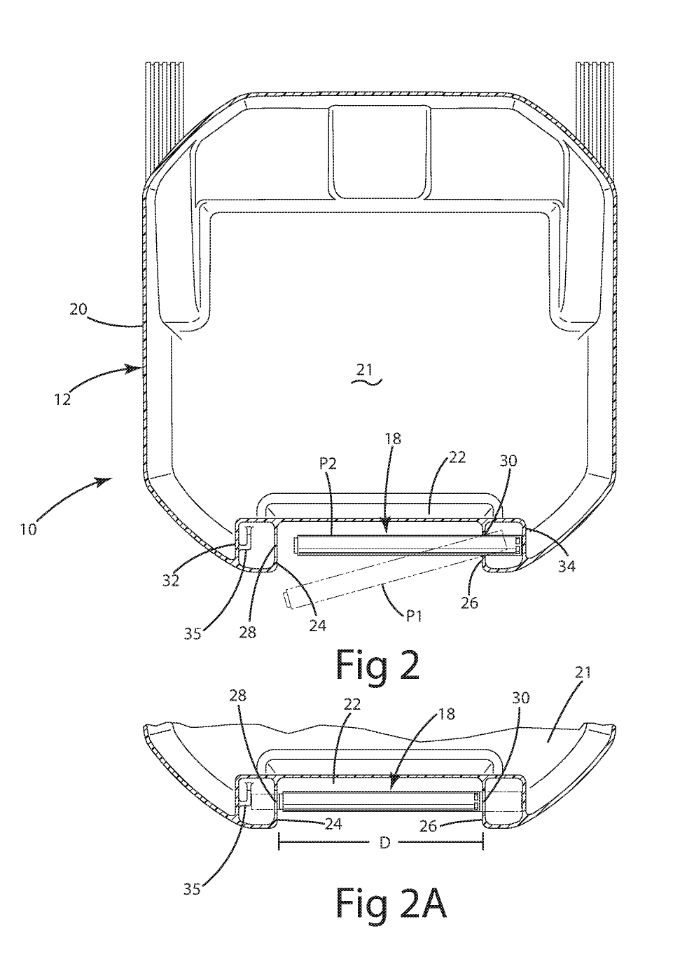

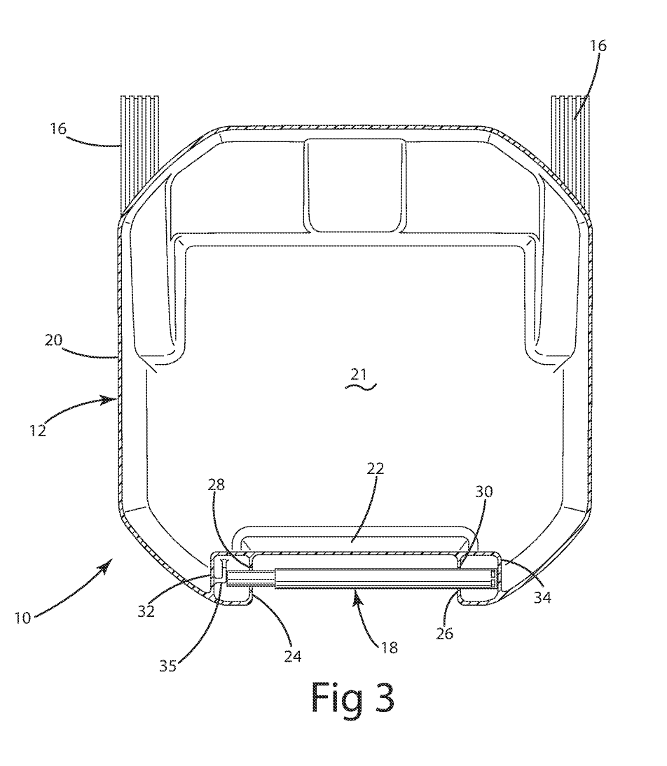

The container 12 (FIGS. 1-3) may have a peripheral wall 20 and a floor 21. The wall 20 may define a lift pocket 22 having pocket sidewalls 24 and 26. The pocket sidewall 24 may define a first hole or opening 28 (see FIG. 2), and the pocket sidewall 26 may define a second hole or opening 30. The pocket sidewalls 24 and 26 are separated by a distance D. The container 12 further includes retaining walls 32 and 34. As shown in FIGS. 2, 2A, and 3, the retaining walls 32 and 34 constrain the lateral movement of the grab bar 18 in the installed position.

As seen in FIGS. 2, 2A, and 3, a stop tab 35 extends from the retaining wall 32 toward the hole 28. Stop tabs are well known in prior art carts. Stop tabs may be included to accommodate the insertion and securement of a prior art fixed-length grab bar within the cart. The illustrated stop tab 35 is L-shaped in cross section. Alternatively, the stop tab may be linear or essentially any other shape or configuration. A stop tab also may be included on the retaining wall 34. The grab bar 18 of the present invention works with carts having one stop tab 35 (as illustrated), two stop tabs, or no stop tabs. When one or two stop tabs 35 are included, the opposite ends of the grab bar 18 engage the stop tab(s). When no stop tabs are included, the opposite ends of the grab bar 18 engage the retaining walls 32 and 34.

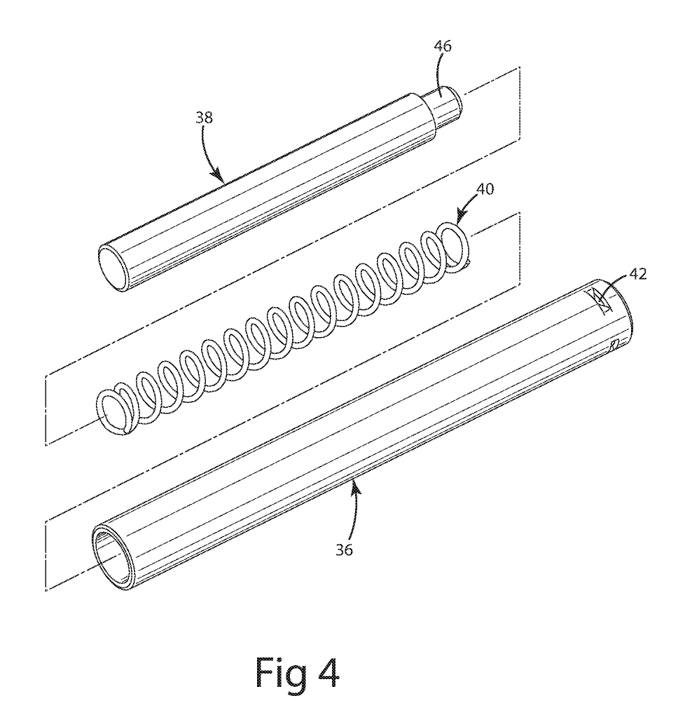

The grab bar 18 (FIGS. 4-6) includes an outer tube 36, a plunger 38, and a spring 40. The plunger 38 is slidably received within the outer tube 36. The spring 40 enables the plunger 38 to be resiliently compressible within the outer tube 36.

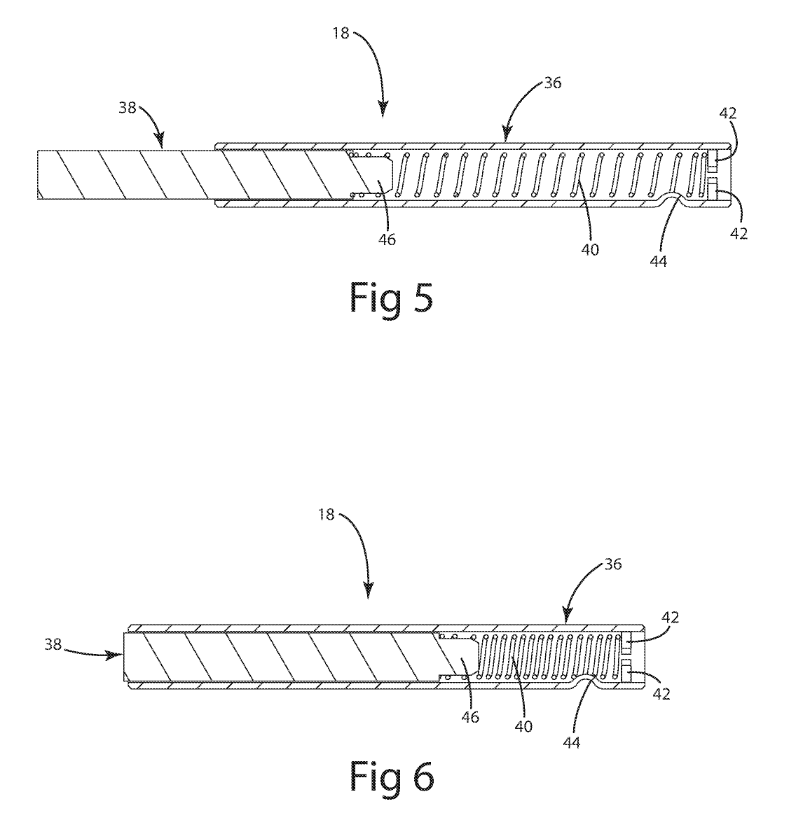

The outer tube 36 is cylindrical in cross section, but may have other cross-sectional shapes. The outer tube 36 may be formed, for example, from a rolled sheet of metal so that the tube includes a longitudinal seam (not visible in the drawings)—i.e. where the rolled edges meet one another. Other suitable techniques and other specifics will be recognized by those skilled in the art and may be dependent, among other factors, on the specific application and use. As seen in FIGS. 5-6, the outer tube 36 is pierced to form a first pair of detents 42, which provide an abutment for one end of the spring 40. The outer tube 36 is deformed to form an inwardly extending detent 44, which retains the spring 40 within the outer tube.

In the current embodiment, the outer tube 36 is fabricated of 13-gauge HRPO HSLA steel (50,000 PSI (pounds per square inch) MIN YIELD) that is 660/60 galvanized. Further in the current embodiment, the outer tube 36 includes a lubrication layer of ECOFORM SVO 95-30 LB PPL on its inner surface. Other suitable materials will be recognized by those skilled in the art and may depend, among other factors, on the specific application and use.

The spring or biasing device 40 in the current embodiment is a coil spring fabricated of 302/304 stainless steel 0.054 inch diameter wire. Further in the current embodiment, the spring 40 is closed on both ends and has approximately 20 coils. Other suitable biasing devices, materials, and specifics will be recognized by those skilled in the art and may be dependent, among other factors, on the specific application and use. While the biasing device 40 of the current embodiment is a coil spring, other suitable biasing devices may be used.

The plunger 38 is generally cylindrical in cross section, but may have other cross-sectional shapes. Preferably, the cross-sectional shapes of the outer tube 36 and the plunger 38 correspond to one another. The plunger 38 includes a nose 46 at one end. The outer diameter of the nose 46 is smaller than the outer diameter of the remainder of the plunger 38. The outer diameter of the nose 46 is selected to receive the coil spring 40 thereon with a friction or interference fit to retain the plunger 38 on the spring. In the current embodiment, the plunger 38 is fabricated of steel having a minimum yield of 10,000 PSI and includes a finish of zinc nickel, DISTIK, SURTEC 684, or CHROMITING HP. Other materials and other specifics will be recognized by those skilled in the art and may be dependent, among other factors, on the specific application and use.

When the grab bar 18 is fully assembled, as illustrated in FIGS. 5-6, the plunger 38 is closely received within the outer tube 36, while still being able to slide freely therein. The plunger 38 is movable between an expanded or uncompressed position illustrated in FIG. 5 and a compressed position illustrated in FIG. 6.

In the uncompressed position of the grab bar 18, the spring 40 is relaxed; one end of the spring is retained in the outer tube 36 by the detent 44; and the other end of the spring is retained on the nose 46 of the plunger 38. Consequently, the parts of the grab bar do not separate from one another except under force.

In the compressed position of the grab bar 18, the spring 40 is compressed (partially or completely); one end of the spring abuts the detents 42; and the other end of the spring abuts the plunger 38. In the compressed position, the length of the grab bar 18 is less than the distance D.

The grab bar 18 may be installed in at least one of two ways within the container 12 of the cart 10. The first way of installing the grab bar 18 is illustrated in FIGS. 2 and 3. First, one end of the grab bar 18 is inserted into the hole 30 as in position P1 illustrated in phantom in FIG. 2. The grab bar 18 is then compressed and moved into the position P2 with the grab bar aligned with whole 28. The grab bar 18 is then released so that it may move to its extended position through the hole 28. The opposite ends of the grab bar 18 preferably are chamfered or otherwise shaped to prevent gouging of the walls of the container 12. In the current embodiment, the grab bar 18, when fully positioned, is somewhat compressed between the retaining walls 32 and 34. However, compression is not required in order for the lower grab bar to be functional, although then it will not have the “self-adjusting” capability described elsewhere in this application. While this way of installing the grab bar calls for first installing the grab bar through the hole 30 and subsequently through the hole 28, it will be readily recognized that the grab bar may be installed first through the hole 28 and subsequently through the hole 30.

The second way of installing the grab bar 18 is illustrated in FIGS. 2A and 3. First, the grab bar is compressed so that its length is less than the distance D. The grab bar then is aligned with both of the holes 28 and 30 as illustrated in FIG. 2A. The grab bar 18 then is released so that it may extend through the holes 28 and 30. Again, in the current embodiment, the grab bar 18, when fully positioned, preferably is somewhat compressed between the retaining walls 32 and 34. Again, the compression is not required.

The lower grab bar 18 has a simple and highly effective construction. The grab bar may be readily and easily installed without tools within the container 12 of the cart 10. The grab bar automatically adjusts in length to accommodate dimensional tolerance issues and installation variations. The grab bar 18 remains securely within the container 12 until positively removed. The grab bar may be readily and easily removed from the container if necessary.

The grab bar 18 “self adjusts” to the flexure of the cart. The grab bar 18 may expand and contract as the container 12 flexes. The grab bar 18 may always contact retaining walls 32 and 34 regardless of flexure of the container. The bar 18 remains in place and fully effective during the entire lifting and tipping cycle.

The grab bar 18 may be retrofitted in the field into a wide variety of carts and containers beyond the specific cart 10 and container 12 disclosed in this application.

The grab bar 18 may be removed from one cart (e.g. a damaged cart) and reused in another cart.

The grab bar 18 does not require additional clips or fasteners to keep it in place.

The grab bar 18 may be used in carts—and specifically within lift pockets—having varying dimensions.

The grab bar 18 may rotate freely an entire 360 degrees about its centerline after the grab bar has been installed in the cart 10.

The above descriptions are those of current embodiments of the invention. Various alterations and changes can be made without departing from the spirit and broader aspects of the invention. Any reference to elements in the singular, for example, using the articles “a,” “an,” “the,” or “said,” is not to be construed as limiting the element to the singular.

1. A waste container assembly comprising:
a waste container defining a lift pocket having first and second sidewalls defining first and second opposed holes respectively; and
a grab bar within the lift pocket and extending through the first and second holes, the grab bar comprising:
a tube;
a spring within the tube; and
a plunger within the tube and engaging the spring, the plunger moveable between compressed and extended positions, the spring biasing the plunger to the extended position.

2. A waste container assembly as defined in claim 1 wherein:
the waste container includes first and second retaining walls aligned with the first and second holes respectively, the first and second holes being outside of the lift pocket; and
the grab bar engages the first and second retaining walls.

3. A waste container assembly as defined in claim 2 wherein:
the waste container is resiliently flexible, the first and second retaining walls moving with respect to one another during flexure of the waste container; and
the grab bar engages the first and second retaining walls during flexure of the waste container.

4. A waste container assembly as defined in claim 1 wherein:
the first and second holes are separated by a distance; and
the length of the grab bar in the compressed position is less than the distance.

5. A waste container assembly as defined in claim 1 wherein the spring is a coil spring.

6. A waste container assembly as defined in claim 5 wherein:
the plunger includes a nose; and
the coil spring is friction fitted ono the nose.

7. A waste container assembly as defined in claim 6 wherein:
the tube includes an inwardly extending detent providing a stop for an end of the coil spring; and
the tube includes an inwardly extending deformation engaging the coil spring to retain the coil spring within the tube.

8. A waste container assembly comprising:
a waste container comprising:
a sidewall defining a lift pocket having first and second sidewalls defining first and second holes separated by a distance; and
first and second retaining walls aligned with the first and second holes respectively, the first and second holes being outside of the lift pocket; and
a grab bar within the lift pocket and extending through the first and second holes, the grab bar engaging the first and second retaining walls, the grab bar comprising:
a tube;
a spring within the tube; and
a plunger within the tube and engaging the spring, the plunger moveable between compressed and extended positions, the spring biasing the plunger to the extended position, the grab bar having a length in the compressed position less than the distance between he first and second holes.

9. A waste container assembly as defined in claim 8 wherein:
the waste container is resiliently flexible, the first and second retaining walls moving with respect to one another during flexure of the waste container; and
the grab bar engages the first and second retaining walls during flexure of the waste container.

10. A waste container assembly as defined in claim 8 wherein the spring is a coil spring.

11. A waste container assembly as defined in claim 10 wherein:
the plunger includes a nose; and
the coil spring is friction fitted ono the nose.

12. A waste container assembly as defined in claim 11 wherein:
the tube includes an inwardly extending detent providing a stop for an end of the coil spring; and
the tube includes an inwardly extending deformation engaging the coil spring to retain the coil spring within the tube.
